(19) United States
(12) Patent Application Publication
(10) Pub. No.: US 2014/0189032 A1
(43) Pub. Date: Jul. 3, 2014

(54) COMPUTER SYSTEM AND METHOD OF CONTROLLING COMPUTER SYSTEM

(71) Applicant: Hitachi, Ltd., Tokyo (JP)

(72) Inventors: Ken Sugimoto, Tokyo (JP); Nobukazu Kondo, Tokyo (JP)

(73) Assignee: Hitachi, Ltd., Tokyo (JP)

(21) Appl. No.: 14/141,056

(22) Filed: Dec. 26, 2013

(30) Foreign Application Priority Data
Dec. 28, 2012 (JP) 2012-286729

(51) Int. Cl. G06F 15/173; H04L 29/08

(52) U.S. Cl. CPC G06F 15/17331; H04L 67/1097
USPC 709/212

(57) ABSTRACT

A computer system have: a plurality of servers; a shared storage system for storing data shared by the servers; and a management server, wherein each of the plurality of servers includes: one or more non-volatile memories for storing part of the data stored in the shared storage system; first access history information storing access status of data stored in the non-volatile memories; storage location information storing correspondence between the data stored in the non-volatile memories and the data stored in the shared storage system; and a first management unit for reading and writing data from and to the non-volatile memories, and wherein the management server includes: second access history information of an aggregation of the first access history information acquired from each of the servers; and a second management unit for determining data to be allocated to the non-volatile memories based on the second access history information.

### CLAIM OF PRIORITY

The present application claims priority from Japanese patent application JP 2012-286729 filed on Dec. 28, 2012, the content of which is hereby incorporated by reference into this application.

### BACKGROUND

This invention relates to a technology of using a shared storage system by a plurality of computers including non-volatile memories.

Almost 100 percent of storage devices mounted on servers have been HDDs (Hard Disk Drives); in recent years, however, non-volatile memories such as flash memory are frequently mounted on servers. For example, a type of flash device connectable with a server via the PCI Express (hereinafter PCIe) interface emerged around 2011 and is gradually spreading. This flash device is called PCIe-SSD. In future, non-volatile memories such as MRAM (Magnetic Random Access Memory), ReRAM (Resistance Random Access Memory), STTRAM (Spin Transfer Torque Random Access Memory), and PCM (Phase Change Memory) are expected to be mounted on servers in various ways.

These non-volatile memories have features of high speed and small capacity compared with the HDD. Hence, they may be used as a cache or a hierarchy in a shared storage system to improve I/O performance between servers and the shared storage system, as well as used as a storage device directly coupled a server like the HDD. This is a technique that configures hierarchies with a shared storage system and the non-volatile memories mounted on the servers to enhance the I/O performance in the overall system.

In using a non-volatile memory directly coupled a server as a cache or a hierarchy of a shared storage system, the capability of copying data between non-volatile memories in servers can further improve I/O performance. Specifically, if data required by some server is in a non-volatile memory in another server, the server can acquire the data from the non-volatile memory in the other server so that the load to the shared storage system is reduced. For a similar example, JP 2003-131944 A discloses a solution to improve I/O performance by enabling data copy between DRAMs in a shared storage system under a clustered shared storage environment.

### SUMMARY

The above-described existing techniques, however, have a problem as follows. Since copying data between servers is merely an alternate means of acquiring data from a shared storage system, each non-volatile memory is allocated only the resources to be used by the local server so that the efficiency in usage of the non-volatile memories of the overall system does not increase. Now, the PCIe-SSD is considered as a non-volatile memory mounted on a server by way of example. Since vendors usually line up only several types of PCIe-SSDs, there may be only two types of PCIe-SSDs: 500-Gbyte and 1100-Gbyte capacity types. If a server requires 800 Gbytes for the capacity of a PCIe-SSD in such a condition, a PCIe-SSD having a capacity of 1100 Gbytes is selected and 300 Gbytes are wasted.

To solve this problem, an approach can be considered that configures non-volatile memories mounted on servers to be readable and writable among the servers and virtualizes the plurality of non-volatile memories to look like a single non-volatile memory. This approach requires both of hierarchization of the virtualized non-volatile memories and a shared storage system and optimization of data allocation to the non-volatile memories among the servers. The latter issue is raised by the fact that data used by some server should preferably be stored in the non-volatile memory of the same server for higher efficiency. In the meanwhile, applications running on a cluster configuration may change by hour; consequently, the data used by the applications may change as well. Furthermore, servers may be replaced or enforced per several months to several years. In view of these two circumstances, the non-volatile memories require dynamic control.

As described above, an object of this invention is to provide a method of dynamically controlling both of hierarchization the non-volatile memories mounted on servers and a shared storage system and optimizing data allocation to the servers.

A representative aspect of the present disclosure is as follows. A computer system comprising: a plurality of servers each including a processor and a memory; a shared storage system for storing data shared by the plurality of servers; a network for coupling the plurality of servers and the shared storage system; and a management server for managing the plurality of servers and the shared storage system, wherein each of the plurality of servers includes: one or more non-volatile memories for storing part of the data stored in the shared storage system; an interface for reading and writing data in the one or more non-volatile memories from and to the one or more non-volatile memories of another server via the network; first access history information storing access status of data stored in the one or more non-volatile memories; storage location information storing correspondence between the data stored in the one or more non-volatile memories and the data stored in the shared storage system; and a first management unit for reading and writing data from and to the one or more non-volatile memories, reading and writing data from and to the one or more non-volatile memories of another server via the interface, or reading and writing data from and to the shared storage system via the interface, and wherein the management server includes: second access history information of an aggregation of the first access history information acquired from each of the plurality of servers; and a second management unit for determining data to be allocated to the one or more non-volatile memories in each of the plurality of servers based on the second access history information.

This invention improves usage efficiency of non-volatile memories mounted on servers as a whole system and optimizes data allocation to the non-volatile memories among the servers. Consequently, the overall computer system achieves higher performance and lower cost together.

### BRIEF DESCRIPTION OF THE DRAWINGS

FIG. 1A is a block diagram illustrating an example of a computer system to which this invention is applied according to an embodiment of this invention.

FIG. 1B is a block diagram illustrating an example of a master server according to an embodiment of this invention.

FIG. 2 illustrates non-volatile memory usage information of local server according to the embodiment of this invention.

FIG. 3 illustrates the non-volatile memory usage information of cluster servers according to the embodiment of this invention.

FIG. 4 illustrates the address correspondence between non-volatile memory and shared storage according to the embodiment of this invention.

FIG. 5 illustrates access history of local server according to the embodiment of this invention.

FIG. 6 illustrates the access history of cluster servers according to the embodiment of this invention.

FIG. 7 is a flowchart illustrating an example of processing when the server performs a read according to the embodiment of this invention.

FIG. 8 is a flowchart illustrating an example of processing when a server performs a write according to the embodiment of this invention.

FIG. 9 is a flowchart illustrating overall processing at the predetermined occasion according to the embodiment of this invention.

FIG. 10 is a detailed flowchart of the processing of the master server to determine new data allocation to the non-volatile memories of the servers according to the embodiment of this invention.

FIG. 11 is a detailed flowchart of the processing of the master server to instruct the servers to register data in or delete data from their non-volatile memories in accordance with the new data allocation according to the embodiment of this invention.

FIG. 12 is a detailed flowchart of registering data in a non-volatile memory of a server according to the embodiment of this invention.

FIG. 13 is a detailed flowchart of the processing of the master server and the servers to delete data in some non-volatile memory according to the embodiment of this invention.

FIG. 14 is a flowchart of initialization performed by the master server and each server according to the embodiment of this invention.

FIG. 15 is a flowchart illustrating an example of the processing performed by the master server and the servers at powering off according to the embodiment of this invention.

### DETAILED DESCRIPTION OF THE EMBODIMENTS

Hereinafter, an embodiment of this invention will be described in detail based on the drawings.

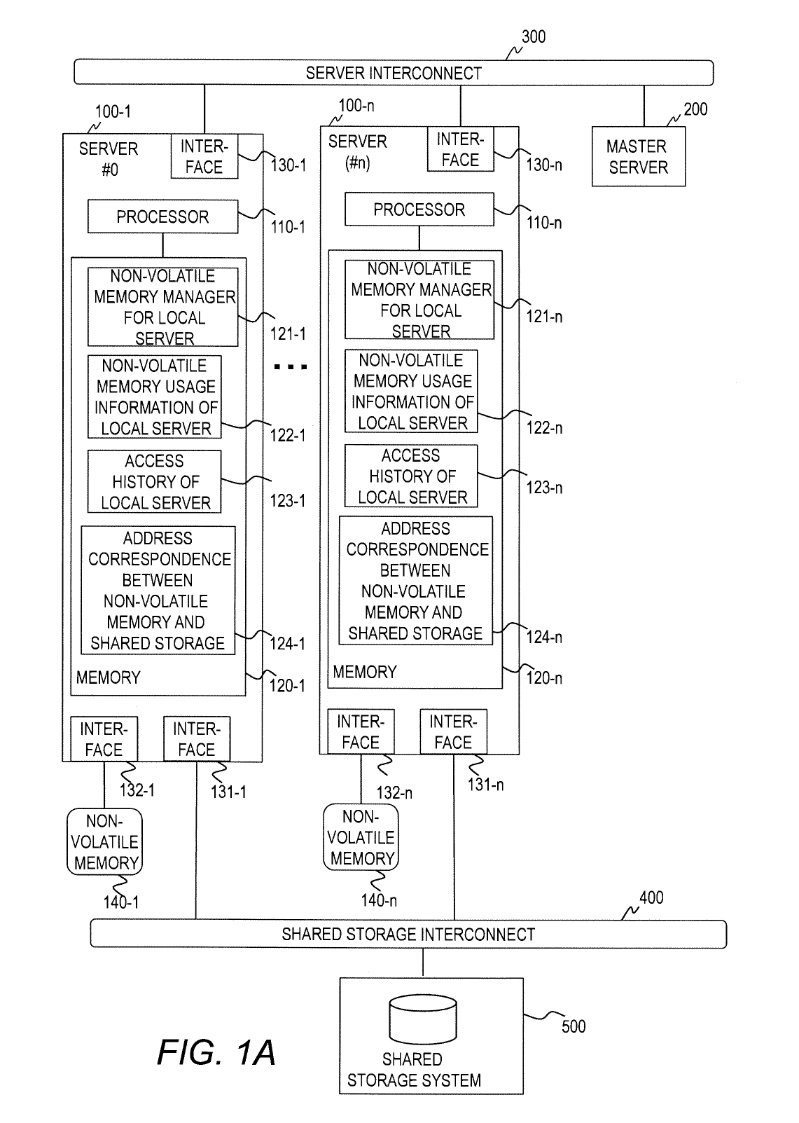

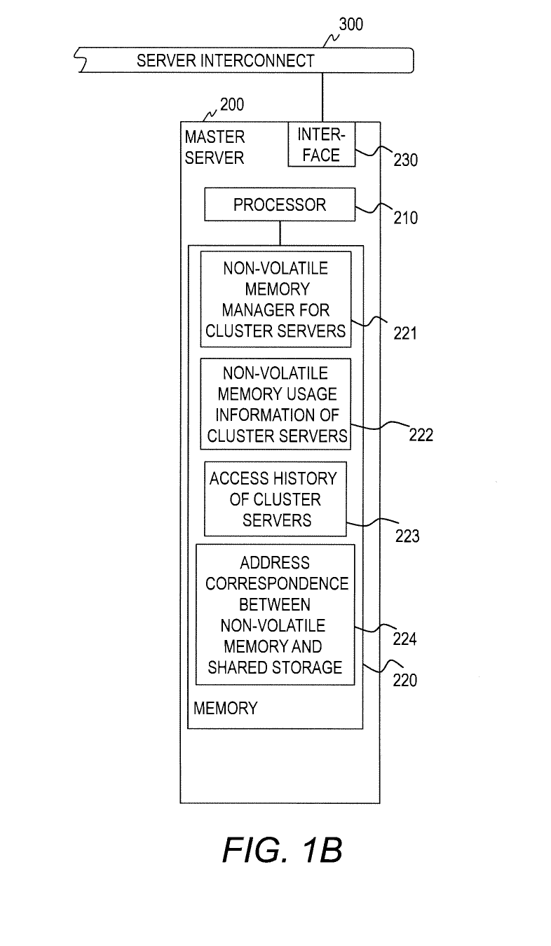

FIG. 1A is a block diagram illustrating an example of a computer system to which this invention is applied. The computer system including servers and a shared storage system in FIG. 1A includes one or more servers 100-1 to 100-n, a master server (management server) 200, a shared storage system 500 for storing data, a server interconnect 300 (or a network) coupling the servers, and a shared storage interconnect 400 (or a network) coupling the servers 100-1 to 100-n and the shared storage system 500. For example, Ethernet-based or InfiniBand-based standards are applicable to the server interconnect 300 coupling the servers 100-1 to 100-n and the master server 200 and Fibre Channel-based standards are applicable to the shared storage interconnect 400.

The server 100-1 includes a processor 110-1, a memory 120-1, a non-volatile memory 140-1, an interface 130-1 for coupling the server 100-1 with the server interconnect 300, an interface 131-1 for coupling the server 100-1 with the shared storage interconnect 400, and an interface 132-1 for coupling the server 100-1 with the non-volatile memory 140-1.

For the interface between the server 100-1 and the non-volatile memory 140-1, it is assumed to use a standard based on PCI Express (PCIe) developed by PCI-SIG (http://www.pcisig.com/). The non-volatile memory 140-1 is composed of one or more storage elements such as flash memories.

The non-volatile memory 140-1 of the server 100-1 and the non-volatile memory 140-n of the server 100-n are interconnected via the interfaces 131-1, 131-n, and the shared storage interconnect 400 to be able to transfer data between the non-volatile memories 140-1 and 140-n using RDMA (Remote Dynamic Memory Access).

To the memory 120-1, a non-volatile memory manager for local server 121-1, non-volatile memory usage information of local server 122-1, access history of local server 123-1, and address correspondence between non-volatile memory and shared storage 124-1 are loaded. The non-volatile memory manager for local server 121-1 is stored in, for example, the shared storage system 500; the processor 110-1 loads the non-volatile memory manager for local server 121-1 to the memory 120-1 to execute it.

The processor 110-1 performs processing in accordance with programs of function units to be the function units to implement predetermined functions. For example, the processor 110-1 performs processing in accordance with the non-volatile memory manager for local server 121-1 (which is a program) to function as a non-volatile memory management unit for local server. The same applies to the other programs. Furthermore, the processor 110-1 functions as function units for implementing a plurality of processes executed by each program. Each computer and the computer system are an apparatus and a system including these function units.

The information such as programs and tables for implementing the functions of the server 100-1 can be stored in the shared storage system 500, a storage device such as a non-volatile semiconductor memory, a hard disk drive, or an SSD (Solid State Drive), or a computer-readable non-transitory data storage medium such as an IC card, an SD card, or a DVD.

Since all the servers 100-1 to 100-n have the same hardware and software as those described above, explanation overlapping with that of the server 100-1 is omitted. The servers 100-1 to 100-n are generally or collectively denoted by a reference numeral 100 without suffix. The same applies to the other elements, which are generally or collectively denoted by reference numerals without suffix.

FIG. 1B is a block diagram illustrating an example of a master server according to an embodiment of this invention. The master server 200 includes a processor 210, a memory 220, and an interface 230. The interface 230 couples the master server 200 with the servers 100-1 to 100-n via the server interconnect 300. To the memory 220-1, a non-volatile memory manager for cluster servers 221, non-volatile memory usage information of cluster servers 222, access history of cluster servers 223, and address correspondence between non-volatile memory and shared storage 224 (FIG. 4) are loaded.

The processor 210 performs processing in accordance with programs of function units to be the function units to implement predetermined functions. For example, the processor 210 performs processing in accordance with the non-volatile memory manager for cluster servers 221 (which is a program) to function as a non-volatile memory management unit for cluster servers. The same applies to the other programs. Furthermore, the processor 210 functions as function units for implementing a plurality of processes executed by each program. Each computer and the computer system are an apparatus and a system including these function units.

The information such as programs and tables for implementing the functions of the master server 200 can be stored in the shared storage system 500, a storage device such as a non-volatile semiconductor memory, a hard disk drive, or an SSD (Solid State Drive), or a computer-readable non-transitory data storage medium such as an IC card, an SD card, or a DVD.

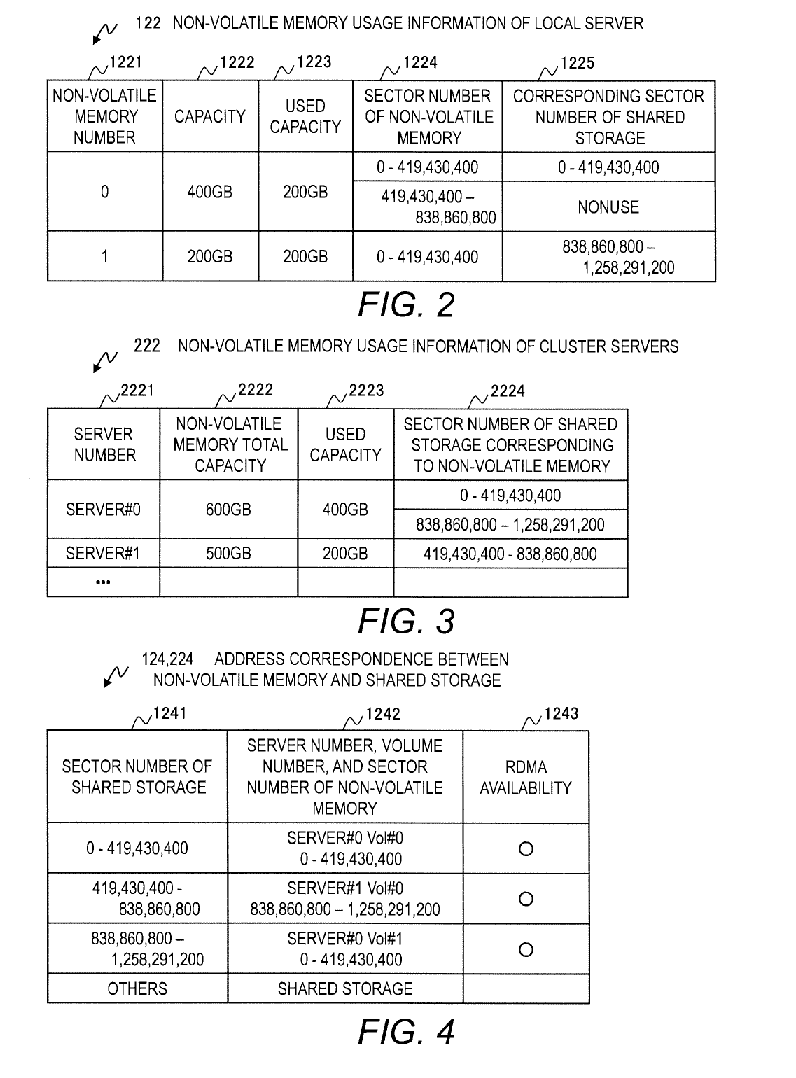

FIG. 2 illustrates non-volatile memory usage information of local server denoted by reference signs 122-1 to 122-n in FIG. 1A. The non-volatile memory usage information of local server is generally denoted by 122.

The non-volatile memory usage information of local server 122 includes non-volatile memory numbers 1221 which are identifiers assigned to individual non-volatile memories mounted on the server 100, capacities 1222 of the individual non-volatile memories 140, used capacities 1223 indicating the amounts used in the individual non-volatile memories 140, sector numbers of non-volatile memories 1224 storing sector numbers used in the non-volatile memories 140, and sector numbers of shared storage 1225 corresponding to the sector numbers of non-volatile memories 1224. If there is no sector number of the shared storage system 500 corresponding to the sector number of non-volatile memory 1224 in use, the corresponding sector number of shared storage 1225 stores a value NONUSE.

FIG. 3 illustrates the non-volatile memory usage information of cluster servers denoted by reference sign 222. The non-volatile memory usage information of cluster servers 222 includes server numbers 2221 storing identifiers of individual servers 100, non-volatile memory total capacities 2222 storing total capacities of the non-volatile memories 140 stored by the individual servers 100, used capacities 2223 storing total amounts of non-volatile memories 140 used by the individual servers 100, and sector numbers of shared storage corresponding to non-volatile memories 2224 storing sector numbers of shared storage system 500 stored in the individual non-volatile memories 140.

FIG. 4 illustrates the address correspondence between non-volatile memory and shared storage denoted by reference signs 124-1 to 124-n and 224 in FIG. 1A and FIG. 1B. The address correspondence between non-volatile memory and shared storage 124 or 224 is a table for managing the locations of data (sector numbers) stored in the non-volatile memories 140-1 to 140-n of the servers 100-1 to 100-n among the data of the shared storage system 500 in association with the identifiers of the servers 100 and the sector numbers of the non-volatile memories 140.

The address correspondence between non-volatile memory and shared storage 124 or 224 includes sector numbers of shared storage 1241 storing sector numbers of the shared storage system 500, server numbers, volume numbers, and sector numbers of non-volatile memories 1242 storing identifies of servers 100 and sector numbers of non-volatile memories 140 corresponding to the sector numbers of shared storage 1241 in the servers 100, and RDMA availabilities 1243 indicating whether the data of the individual entries can be accessed using RDMA. Each server number, volume number, and sector number of non-volatile memory includes a server number including the non-volatile memory 140 storing the data, a non-volatile memory number (one of Vol. #0 to Vol. #n), and the sector number of the non-volatile memory 140, and information indicating that the data is in the shared storage system 500. The availability of RDMA is determined depending on whether the non-volatile memory 140 supports RDMA from another server 100, and is temporarily set to be unavailable during registration of data in the non-volatile memory 140. The RDMA availability 1243 stores “∘” if available.

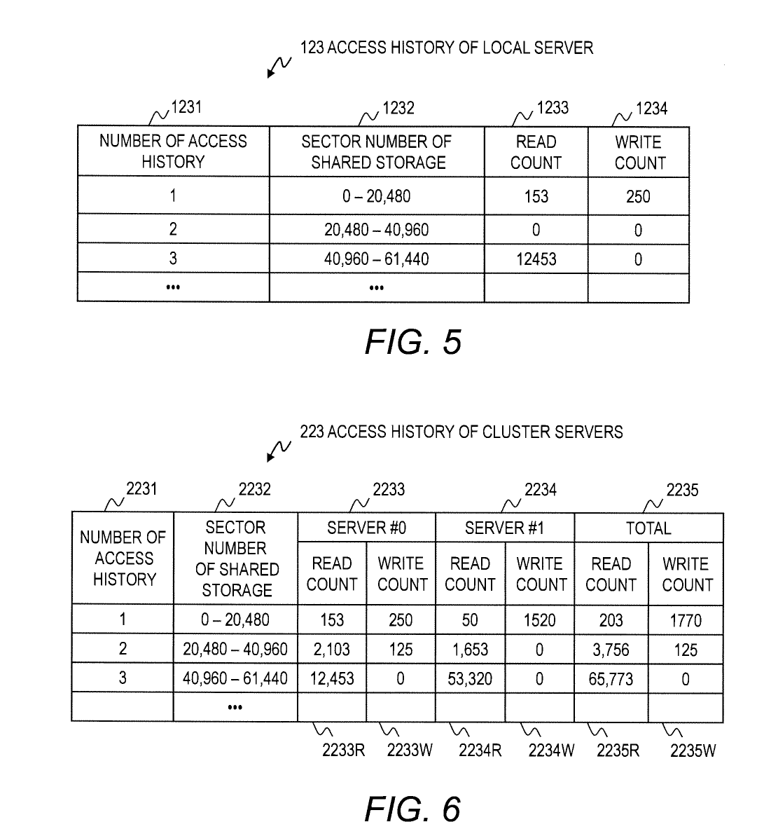

FIG. 5 illustrates access history of local server denoted by reference signs 123-1 to 123-n in FIG. 1A. The access history of local server 123 includes numbers of access histories 1231, sector numbers of shared storage 1232 stored in the non-volatile memory 140, and read counts 1233 and write counts 1234 acquired in individual numbers of access histories 1231. Each number of access history 1231 indicates a unit of non-volatile memory 140 for the server 100 to count accesses and represented by, for example, a volume number or a block number. Each of the read counts 1233 or the write counts 1234 stores the sum of the accesses to the non-volatile memory 140 of the local server 100 and the accesses to the shared storage system 500.

FIG. 6 illustrates the access history of cluster servers denoted by the reference sign 223 in FIG. 1B. The access history of cluster servers 223 includes numbers of access histories 2231, sector numbers of shared storage 2232, read counts and write counts 2233 (2233R, 2233W) and 2234 (2234R and 2234W) acquired by the individual servers 100 in individual numbers of access histories 2231, and total read counts 2235R and total write counts 2235W acquired by all the servers 100-1 to 100-n in individual numbers of access histories 2231. The example of FIG. 6 shows a case of two servers 100.

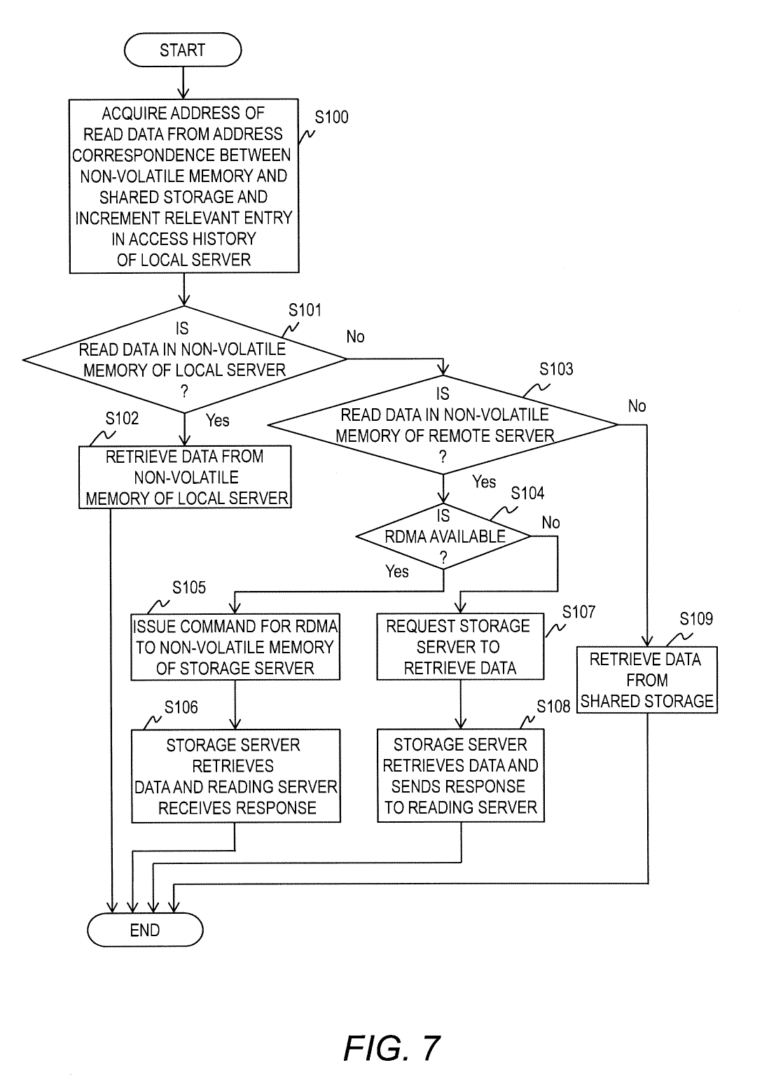

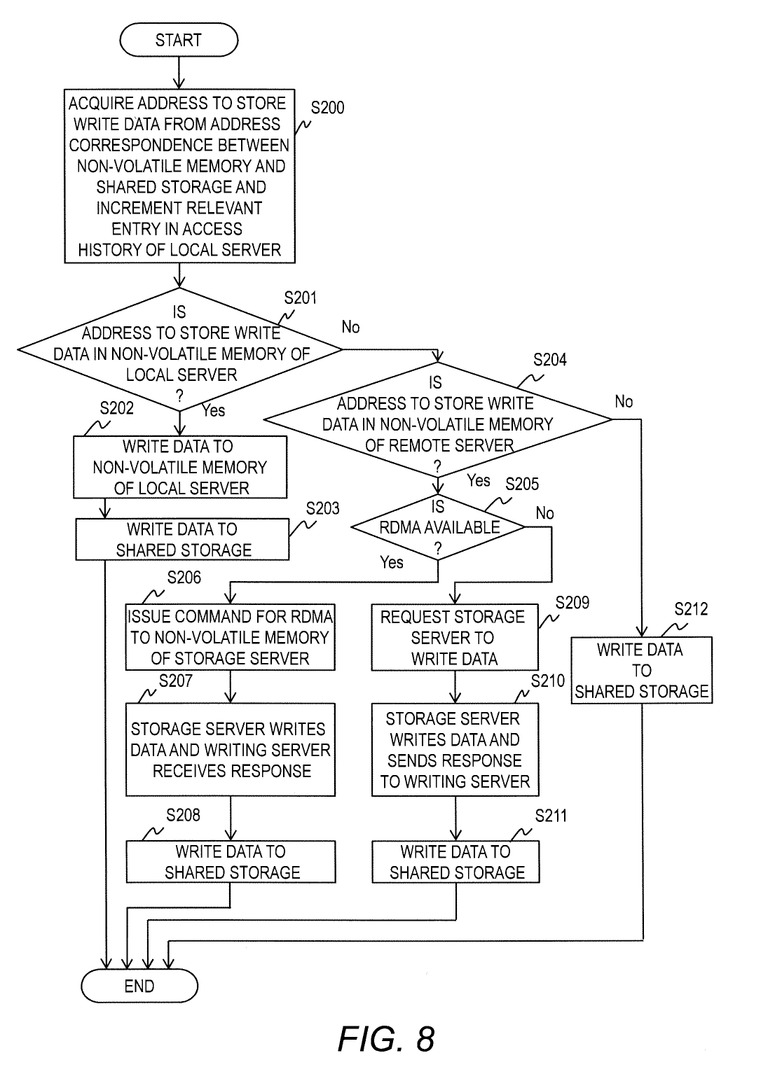

FIGS. 7 and 8 are flowcharts of reading and writing in this invention. Hereinafter, processing of reading and writing is explained with FIGS. 7 and 8.

FIG. 7 is a flowchart illustrating an example of processing when the server 100 performs a read. This processing is executed by the non-volatile memory manager for local server 121 when a not-shown application or OS running on the server 100 has issued a request for data read.

First, at Step S100, the server 100 checks whether the data to be read is in any of the non-volatile memories 140 with reference to the sector number of the shared storage system 500 to read and the address correspondence between non-volatile memory and shared storage 124 and, if the read data is in one of the non-volatile memories 140, retrieves the address storing the data. Further, the server 100 increments the read count 1233 of the corresponding entry in the access history of local server 123.

Next, at Step S101, the server 100 determines whether the read data is in the non-volatile memory 140 of the local server 100. If the read data is in the non-volatile memory 140 of the local server 100, the server 100 proceeds to Step S102. At Step S102, it retrieves the data from the non-volatile memory 140 of the local server 100. The address to read the data can be acquired from the address correspondence between non-volatile memory and shared storage 124.

If, at Step S101, the address correspondence between non-volatile memory and shared storage 124 does not indicate that the read data is in the non-volatile memory 140 of the local server 100, the server 100 proceeds to Step S103 to determine whether the read data is in the non-volatile memory 140-n of a remote server 100-n (hereinafter, storage server 100-n).

If the read data is in a remote server 100-n, the server 100 proceeds to Step S104 to determine whether RDMA is available with the storage server 100-n storing the read data with reference to the RDMA availability 1243 in the address correspondence between non-volatile memory and shared storage 124.

If RDMA is available, the server 100 proceeds to Step S105 to retrieve the data from the non-volatile memory 140-n of the storage server 100-n storing the read data using RDMA. In the RDMA, the server interconnect 300 can be used as a data communication path.

As a result, at Step S106, the data is retrieved from the non-volatile memory 140-n of the storage server 100-n storing the read data and the reading server 100 that has requested the data receives a response. To retrieve data from the non-volatile memory 140-n of a remote server 100-n using RDMA, there is a standard called SRP (SCSI RDMA Protocol).

If, at Step S104, RDMA is unavailable with the storage server 100-n storing the read data, the reading server 100 proceeds to Step S107 to request the storage server 100-n to retrieve the data from the non-volatile memory 140-n.

At Step S108, the processor 110-n of the storage server 100-n retrieves the requested data from the non-volatile memory 140-n or the shared storage system 500 and returns a response to the reading server 100.

If RDMA is unavailable, data is transmitted between the processors 110 of the servers 100. The server interconnect 300 can be used as a data communication path.

If the determination at S103 is that the read data is not in the non-volatile memory 140-n of the remote server 100-n either, the server 100 determines that the read data is not in the non-volatile memories 140 in the overall computer system and proceeds to Step S109 to retrieve the data from the shared storage system 500.

In the foregoing processing, the server 100 to read data that has received a read request preferentially retrieves data from the non-volatile memory 140 of the local server or the non-volatile memory 140-n of the remote server 100-n using the non-volatile memory manager for local server 121, achieving efficient use of data in the shared storage system 500.

FIG. 8 is a flowchart illustrating an example of processing when a server 100 performs a write. This processing is executed by the non-volatile memory manager for local server 121 when a not-shown application or OS running on the server 100 has issued a request for data write.

First, at Step S200, the server 100 acquires the sector number of the shared storage system 500 to write to check whether the address to store write data is in the non-volatile memories 140 with reference to the address correspondence between non-volatile memory and shared storage 124, and retrieves the address to store the data. Further, the server 100 increments the write count 1234 of the corresponding entry in the access history of local server 123.

Next, at Step S201, the server 100 determines whether the address to store the write data is in the non-volatile memory 140 of the local server 100. If the address to store the write data is in the non-volatile memory 140 of the local server 100, the server 100 proceeds to Step S202 to write the data to the non-volatile memory 140 of the local server 100. The write address can be acquired from the address correspondence between non-volatile memory and shared storage 124.

At Step S203, the server further writes the data written to the non-volatile memory 140 to the shared storage system 500.

If the determination at Step S201 is that the address to store the write data is not in the non-volatile memory 140 of the local server 100, the server 100 proceeds to Step S204 to determine whether the address to store the write data is in the non-volatile memory 140-n of a remote server 100-n. If the address to store the write data is in the non-volatile memory 140-n of a remote server 100-n, the server 100 proceeds to Step S205 to determine whether RDMA is available with the remote server 100-n. If RDMA is available with the remote server 100-n, the server 100 proceeds to Step S206 to write the data to the non-volatile memory 140-n of the remote server 100-n to store the data using RDMA.

Next, at Step S207, when the data has been written to the non-volatile memory 140-n of the storage server 100-n, the server 100 writing the data receives a response from the interface 131-n of the remote server 100-n that has actually written the data.

Then, at Step S208, the server 100 writes the data written to the non-volatile memory 140-n of the remote server 100-n to the shared storage system 500.

If the determination at Step S205 is that RDMA is unavailable with the remote storage server 100-n, the server 100 proceeds to Step S209. At Step S209, the writing server 100 requests the storage server 100-n to write the data in the non-volatile memory 140 to the non-volatile memory 140-n.

Next, at Step S210, the storage server 100-n writes the data retrieved from the server 100 to the non-volatile memory 140-n and returns a response to the writing server 100. After receipt of the response, the writing server 100 requests the remote server 100-n to write the data written to the non-volatile memory 140-n to the shared storage system 500.

If RDMA is unavailable, the data is transmitted between the processors 110 of the servers 100 like in the above-described reading. In this case, the server interconnect 300 can be used as a data communication path.

If the determination at foregoing Step S204 is that the address to store the write data is not in the non-volatile memory 140-n of the remote server 100-n, the server 100 determines that the address to store the write data is not in any of the non-volatile memories 140 in the whole computer system and writes the data to the shared storage system 500 at Step S212.

In the foregoing processing, the server 100 to write data that has received a write request preferentially writes data to the non-volatile memory 140-1 of the local server 100-1 or the non-volatile memory 140-n of the remote server 100-n, achieving efficient use of data in the shared storage system 500.

In FIGS. 7 and 8, the overhead of the processor 110 to perform reading or writing in this computer system is only retrieving the data storage address of read data or write data from the address correspondence between non-volatile memory and shared storage 124 and incrementing the relevant entry in the access history of local server 123, which is unlikely to cause a problem for the overhead in I/O processing.

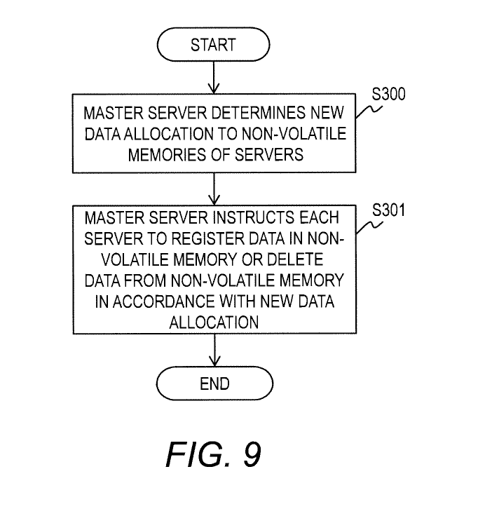

Next, with reference to FIGS. 9, 10, 11, 12, and 13, processing of the master server 200 to register data to the non-volatile memories 140 of the servers 100 will be described.

The master server 200 follows a flowchart to change data storage allocation to the non-volatile memories 140 of the servers 100 at predetermined intervals or at a predetermined occasion. FIG. 9 is a flowchart illustrating overall processing at the predetermined occasion. This processing is executed by the non-volatile memory manager for cluster servers 221 in the master server 200 and the non-volatile memory manager for local server 121 in each server 100.

First, at Step S300, the master server 200 determines new data allocation to the non-volatile memories 140 of the servers 100. Next, at Step S301, the master server 200 instructs each server 100 to register data in its own non-volatile memory 140 or delete data from its own non-volatile memory 140 in accordance with the new allocation determined at Step S300.

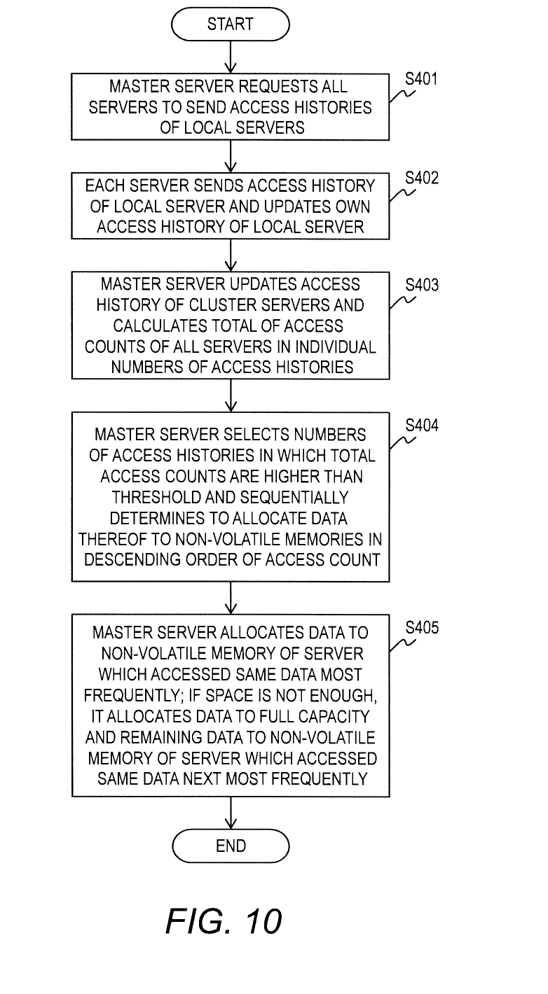

FIG. 10 is a detailed flowchart of the processing of the master server 200 to determine new data allocation to the non-volatile memories 140 of the servers 100, which corresponds to Step S300 in FIG. 9. This processing is executed by the non-volatile memory manager for cluster servers 221 in the master server 200 and the non-volatile memory manager for local server 121 in each server 100. The same applies to the following flowcharts.

First, at Step S401, the master server 200 requests all servers 100 to send their own access histories of local servers 123. In response, each server 100 sends the access history of local server 123 to the master server 200 at Step S402.

After sending the access history of local server 123 to the master server 200, each server 100 updates the values of the read counts 1233 and the write counts 1234. In resetting the values, each server 100 reduces the values to, for example, 0 or a half.

At Step S403, the master server 200 receives the access histories of local servers 123 from the servers 100 and updates the access history of cluster servers 223 based on these access histories of local servers 123.

The master server 200 calculates totals 2235 of the access counts 2233 and 2234 of all servers 100 in individual numbers of access histories 2231. In this calculation, weighting such as different weighting depending on the server 100 or different weighting between read and write may be employed. By setting the weight to some number of access history 2231 of some server 100 at infinity, the data can be fixed to the server 100.

Next, at Step S404, the master server 200 sorts the numbers of access histories 2231 in the access history in cluster servers 223 in descending order of total accesses 2235 from all servers 100. This sorting may be performed based on a predetermined condition, such as the sum of the read count 2235R and the write count 2235W or either one of the read count 2235R and the write count 2235W in the totals in servers 2235.

The master server 200 selects the numbers of access histories 2231 for which the total accesses 2235 are higher than a predetermined threshold and sorts them in descending order of access count. Then, the master server 200 sequentially allocates data in the amount that does not exceed the capacity of the non-volatile memories 140 of the servers 100. The aforementioned threshold can be determined in a specific condition, such as a threshold determined for the sum of the read count 2235R and the write count 2235W or thresholds individually determined for the read count 2235R and the write count 2235W.

Then, at Step S405, the master server 200 determines what data is to be allocated to which server of 100-1 to 100-n depending on the access counts 2233 and 2234 in each number of access history 2231 of individual servers 100.

This determination of allocation attempts to allocate data that the master server 200 has determined to allocate to any of the non-volatile memories 140 to the non-volatile memories 140 of the servers 100-1 to 100-n in order from the server that accessed to the data most frequently. If the non-volatile memory 140 of the first server 100 has a remaining space, the master server 200 stores the data determined at S404 to the first server 100 and if the non-volatile memory 140 does not have an enough space, the master server 200 allocates the data in the amount of space remaining in the non-volatile memory 140 of the server 100 and allocates the excessed data to the second server 100 which accessed the data next most frequently. If there exist a plurality of servers 100 which accessed with the same frequency, the master server 200 can take a well-known or publicly-known method to determine the server 100, for example, by selecting the server 100 having the most remaining space in the non-volatile memory 140 or a random server 100.

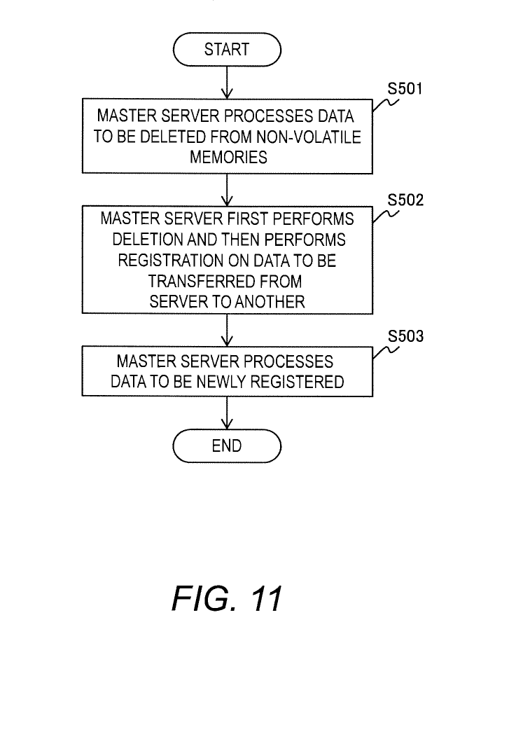

FIG. 11 is a detailed flowchart of the processing of the master server 200 to instruct the servers 100 to register data in or delete data from their non-volatile memories 140 in accordance with the new data allocation, which is the processing corresponding to Step S301 in FIG. 9.

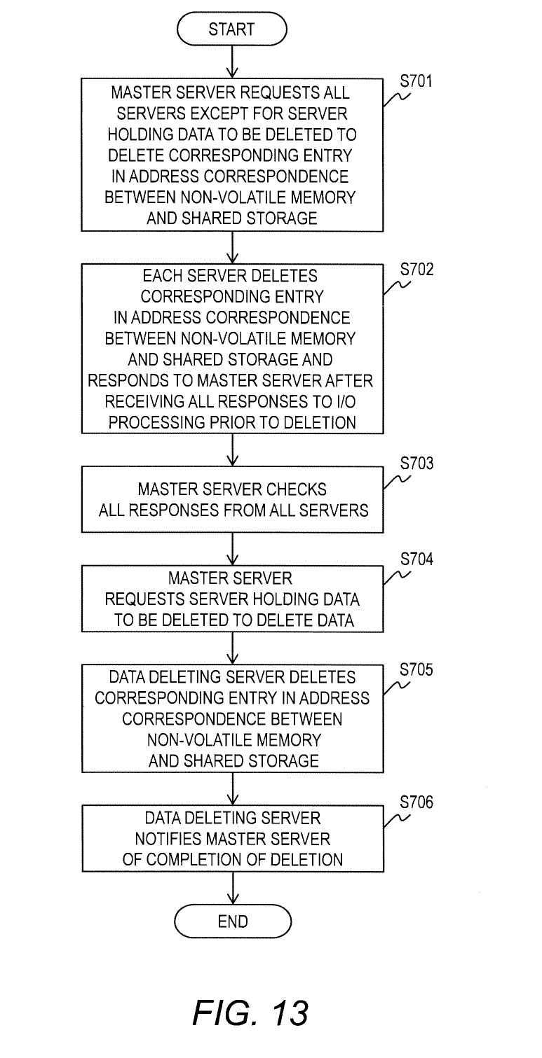

First, at Step S501, the master server 200 selects data to be deleted from non-volatile memories 140 and deletes the data. This selecting data to be deleted is, for example, selecting, by the master server 200, data that has been determined to be deleted from non-volatile memories 140 and to be read or written only in the shared storage system 500 because of the reduction in access. The master server 200 instructs each server 100 to delete the data to be transferred which is currently stored in the non-volatile memory 140. The server 100 which has received this instruction deletes the designated data from the non-volatile memory 140. The details of deleting data will be described later with FIG. 13.

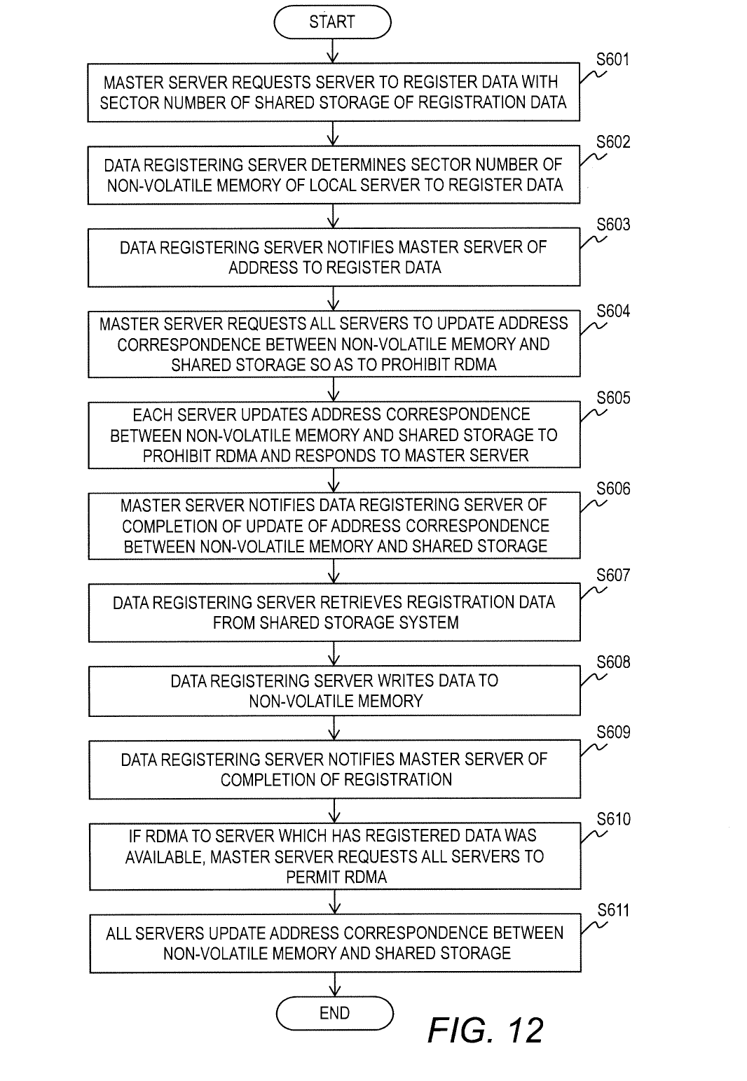

Next, at Step S502, the master server 200 selects data to be transferred from the non-volatile memory 140 of some server 100 to the non-volatile memory 140-n of a different server 100-n, deletes the data in the same way as the foregoing Step S501, and then registers the data. In registering, the master server 200 notifies a destination server 100-n of the sector number in the shared storage system 500 of the registration data and instructs the server 100-n to register the data. The instructed server 100-n retrieves the data at the designated sector number from the shared storage system 500 and stores it in its non-volatile memory 140-n. The details of registering data will be described later with FIG. 12.

Finally, at Step S503, the master server 200 adds data determined to be newly registered in the non-volatile memories 140 to the non-volatile memories 140. The data determined to be newly registered means the data which is not currently stored in the non-volatile memory 140 but stored in only the shared storage system 500 but has determined to be registered in the non-volatile memory 140 because of increase in access.

In the processing at the foregoing Step S502, registration may be performed before completion of deletion of all data; as a result, the space of the non-volatile memory 140 of some server 100 might be short. In such a case, transferring different data first can solve the problem since deleting data from the non-volatile memory 140 of the server 100 which does not have enough remaining space is performed at some time.

The reason why the deletion is performed prior to the registration at Step S502 is to maintain coherency among servers 100. That is to say, if registration is performed first, the system includes a plurality of copies of data; if some server 100 performs a write under such a circumstance, coherency might be lost unless simultaneously writing to all the copies of data. However, the write in this computer system is performed as illustrated in FIG. 8, which does not provide such a mechanism. Therefore, deleting data before registering data can maintain the number of copies of data in the shared storage system 500 to be one among the non-volatile memories 140, which keeps coherency.

FIG. 12 is a detailed flowchart of registering data in a non-volatile memory 140 of a server 100, which is the processing at Steps S502 and S503 in FIG. 11.

In registering data in a non-volatile memory 140 of a server 100, first at Step S601, the master server 200 requests the server 100 to register the data and notifies the server of the sector number of shared storage of the registration data.

Here, the amount of space of the non-volatile memory 140 of the server 100 to register the data is stored in the non-volatile memory total capacity 2222 and the used capacity 2223 in the non-volatile memory usage information of cluster servers 222 in the master server 200; accordingly, a problem that the lack of the space of the non-volatile memory 140 of the server 100 to register the data does not allow the data registration will not occur.

Next, at Step S602, the data registering server 100 refers to the non-volatile memory usage information of local server 122 to determine the non-volatile memory number 1221 and the sector number of non-volatile memory 1224 to register the data in the non-volatile memory 140 of the local server.

Then, at Step S603, the data registering server 100 notifies the master server 200 of the address to register the data. This address to register the data includes the identifier of the server 100 (server number 2221), a non-volatile memory number, and a sector number of non-volatile memory, like the server number, volume number, and sector number of non-volatile memory 1242 in the address correspondence between non-volatile memory and shared storage 124.

Next, at Step S604, the master server 200 requests all the servers 100 to update their own address correspondence between non-volatile memory and shared storage 124 by changing the entry containing the address to register the data in the sector number of shared storage 1241 to prohibit the use of RDMA. The use of RDMA can be prohibited by changing the field of the RDMA availability 1243 in the address correspondence between non-volatile memory and shared storage 124 of each server 100 into a blank.

At Step S605, each server 100 updates the address correspondence between non-volatile memory and shared storage 124 with a mode that does not allow RDMA and returns a response to the master server 200. The master server 200 receives responses from all the servers 100 at Step S606 and notifies the data registering server 100 of the completion of update of the address correspondence between non-volatile memory and shared storage 124.

At Step S607, the data registering server 100 retrieves the registration data from the shared storage system 500; at Step S608, it writes the data retrieved from the shared storage system 500 to the non-volatile memory 140.

At Step S609, the data registering server 100 notifies the master server 200 of the completion of registration. At Step S610, the master server 200 instructs all the servers 100 to update their own address correspondence between non-volatile memory and shared storage 124 by changing the relevant entry to use RDMA, if RDMA to the non-volatile memory 140 that has registered the data was available. Finally, at Step S611, each server 100 updates the address correspondence between non-volatile memory and shared storage 124.

The processing from Steps S603 to S606 is performed to control coherency of registration data. Specifically, when the data registering server retrieves the data in the shared storage system 500 to the non-volatile memory 140 at some time, another server 100-n may update the data during the data retrieval. In such a situation, the data in the non-volatile memory 140 is different from the data in the shared storage system 500, losing coherency. For this reason, the master server 200 first prohibits all the servers 100 that may update the data from using RDMA through the address correspondence between non-volatile memory and shared storage 124 so that the data registering server 100 can grasp all data updates from the start to the end of data retrieval.

In response to a read executed by one of the servers 100 before completion of data retrieval, the data retrieving server 100 retrieves the data from the shared storage system 500. In response to a write executed by one of the servers 100 before completion of data retrieval, the data retrieving server 100 records the data in the buffer of the data registering server 100. Subsequently, in registering the data included in the buffer in the non-volatile memory 140 or the processing at Step S608, the server 100 overwrites the data retrieved from the shared storage system 500. This way, the coherency of data between the shared storage system 500 and the non-volatile memory 140 in the data registering server 100 can be maintained. Finally at Steps 610 and S611, the RDMA is returned to be available since the RDMA improves I/O performance.

FIG. 13 is a detailed flowchart of the processing of the master server 200 and the servers 100 to delete data in some non-volatile memory 140, which is the processing at Steps S501 and S502 in FIG. 11.

In deleting data from a non-volatile memory 140 of a server 100, first at Step S701, the master server 200 requests all the servers 100 except for the server 100 storing the data to be deleted to delete the corresponding entry in the address correspondence between non-volatile memory and shared storage 124.

At Step S702, each server 100 deletes the corresponding entry in the address correspondence between non-volatile memory and shared storage 124 and returns a response to the master server 200 after receiving responses to all I/Os issued prior to deleting the entry.

At Step S703, the master server 200 waits for arrival of the responses from all servers 100 and, at Step S704, the master server 200 requests the server 100 storing the data to be deleted to delete the data.

At Step S705, the server 100 deleting the data deletes the corresponding entry in the address correspondence between non-volatile memory and shared storage 124 and, finally at Step S706, the server 100 notifies the master server 200 of completion of deletion.

In the above-described processing, the reason why each server 200 at Step S702 does not return a response immediately but does after receiving responses to all I/O processing prior to the deletion is to prevent a read or write after new data has been written to the address in the case where some I/O prior to the deletion of the entry is delayed.

As set forth above, the processing of FIGS. 7 to 13 achieves dynamic control for hierarchized data among the non-volatile memories 140 mounted on the servers 100 and the shared storage system 500 and for optimizing data allocation among the servers 100.

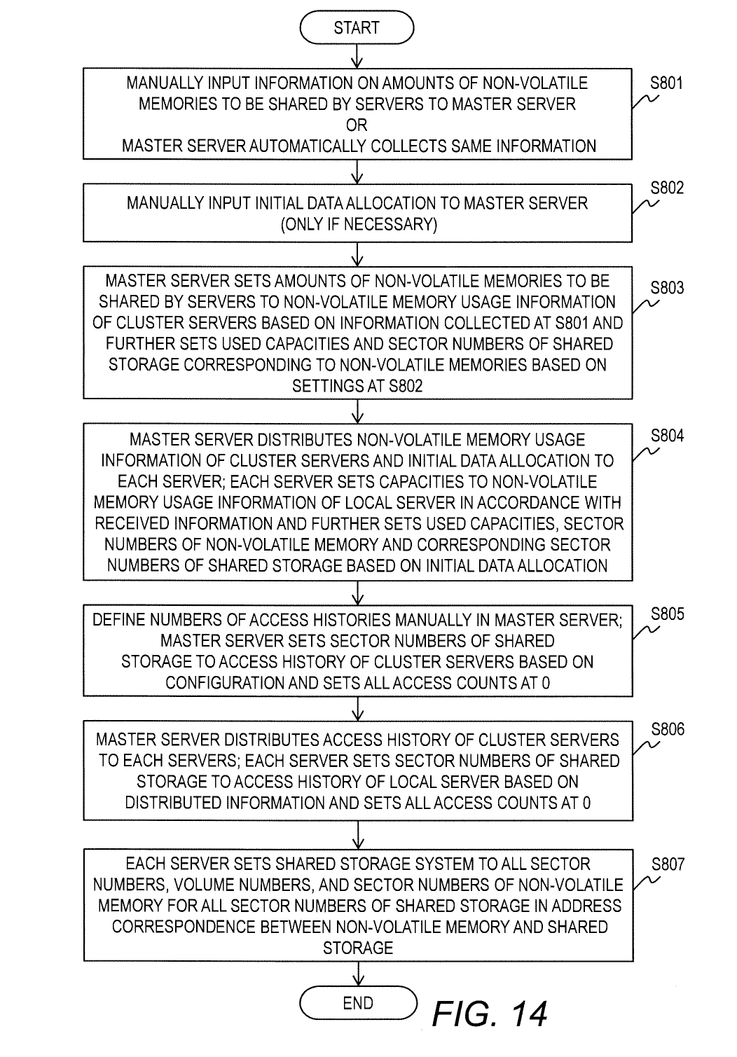

FIG. 14 is a flowchart of initialization performed by the master server 200 and each server 100. The initialization means initialization of the tables shown in FIGS. 2 to 6. At Step S801, what amount of the non-volatile memory 140 of which server 100 is to be shared among the servers 100 is set to the master server 200.

This step may be performed by manually inputting each amount to a not-shown input device of the master server 200 or by automatically determining each amount based on information collected by the master server 200 from each server 100.

Next, at Step S802, the initial data allocation is manually specified at the master server 200 as necessary. For example, if data frequently accessed is known in the shared storage system 500, the administrator may initially determine to allocate the data to the non-volatile memories 140 of the servers 100. As a result, performance improvement by installation of non-volatile memories 140 can be achieved upon start-up of the system.

At Step S803, the master server 200 sets the non-volatile memory total capacities 2222 to the non-volatile memory usage information of cluster servers 222 based on the information of the amounts of non-volatile memories 140 of the servers 100 collected at Step S801 and sets used capacities 2223 and sector numbers of shared storage corresponding to non-volatile memories 2224 based on the settings at Step S802. Next, at Step S804, the master server 200 distributes the non-volatile memory usage information of cluster servers 222 and the initial data allocation determined at S802 to each server 100. Each server 100 sets the capacities 1222 to the non-volatile memory usage information of local server 122 in accordance with the non-volatile memory usage information of cluster servers 222. Each server 100 further sets the used capacities 1223, sector numbers of non-volatile memory 1224, and corresponding sector numbers of shared storage 1225 to the non-volatile memory usage information of local server 122 based on the initial data allocation determined at S802.

Next, at Step S805, the master server 200 defines numbers of access histories 2231 to the access history of cluster servers 223. In defining the numbers of access histories, the non-volatile memories may be divided to units having a predetermined size, for example 200 Mbytes, or divided to units including different types of data used by applications running on the servers 100. In the case of a database as an example of the latter case, indices and data may be regarded as different units. The master server 200 sets the numbers of access histories 2231 and sector numbers of shared storage 2232 to the access history of cluster servers 223 based on the so-defined numbers of access histories 2231. The master server 200 sets all the access counts 2233 and 2234 in the access history of cluster servers 223 at 0.

At Step S806, the master server 200 distributes the access history of cluster servers 223 to each server 100. Each server 100 sets sector numbers of shared storage 1232 to the access history of local server 123 based on the distributed information and sets all the access counts 1233 and 1234 at 0.

Finally, at Step S807, all the servers including the master server 200 configures their own address correspondence between non-volatile memory and shared storage 124 and 224 by setting shared storage system 500 to the server numbers, volume numbers and sector numbers of non-volatile memory 1242 for all the sector numbers of shared storage.

Through the above-described processing, initialization of all the tables is completed.

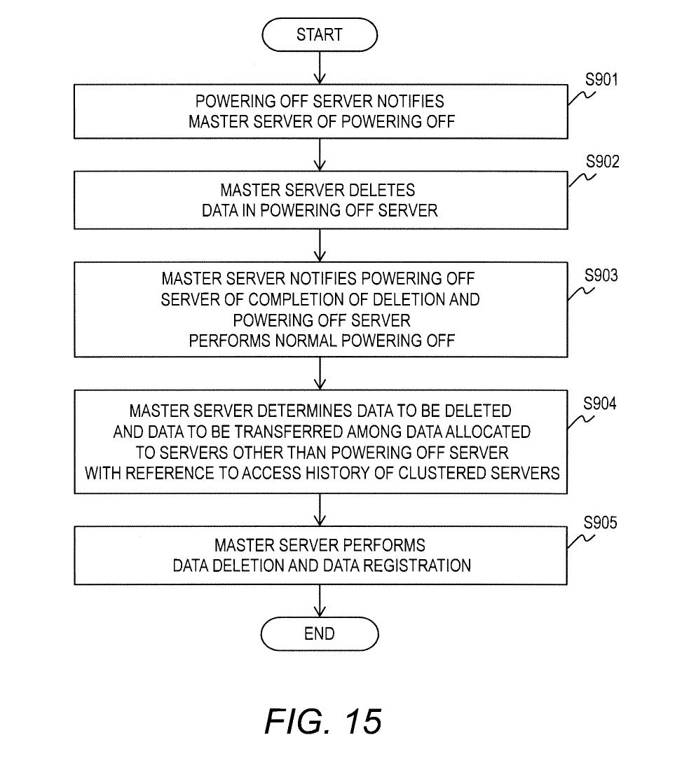

In the above-described environment, if another server 100-n accesses the non-volatile memory 140 of some powered-off server 100, a problem will arise that the server 100-n never receives a response. To cope with this problem, in powering off a server 100, the master server 200 has to first make reconfiguration so as not to use the non-volatile memory 140 of the server 100 to be powered off before powering off the server 100. FIG. 15 is a flowchart illustrating an example of the processing in such a case.

FIG. 15 is a flowchart illustrating an example of the processing performed by the master server and the servers at powering off.

First, at Step S901, the powering off server 100 notifies the master server 200 of the powering off.

At Step S902, after receiving the notice of powering off from the server 100, the master server 200 deletes the data in the non-volatile memory 140 of the powering off server 100. This operation leads none of the servers 100 to access the non-volatile memory 140 of the powering off server 100.

At Step S903, the master server 200 notifies the powering off server 100 of the completion of the deletion. Then, the powering off server 100 returns to the normal processing of powering off.

Next at Step S904, the master server 200 determines data to be deleted from the non-volatile memories 140 and data to be newly registered in the data allocation among the servers other than the powering off server 100 with reference to the access history of cluster servers 223. This processing is performed because the temporal data allocation is not optimum due to the deletion of the data in the powering off server 100. Finally at Step S905, the master server 200 deletes and registers data.

In the cluster environment of servers 100, which data is to be allocated to which server 100 can be statically and manually determined. However, the cluster environment varies since the running applications are completely different between day and night and the number of servers 100 or the capacity of non-volatile memory 140 in each server 100 are changed because of system replacement or enforcement per several months to several years. In view of these circumstances, it seems almost impossible to statically and manually determine data allocation. In this computer system, the master server 200 dynamically determines data allocation, coping with the aforementioned situations.

The foregoing embodiment employs sector numbers as locational information for data in the shared storage system 500 by way of example; however, block numbers or logical block addresses may be used.

The elements such as servers, processing units, and processing means described in relation to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiment but includes various modifications. For example, the foregoing embodiment has been provided to explain this invention to be easily understood; it is not limited to the configuration including all the described elements.

What is claimed is:

1. A computer system comprising:
a plurality of servers each including a processor and a memory;
a shared storage system for storing data shared by the plurality of servers;
a network for coupling the plurality of servers and the shared storage system; and
a management server for managing the plurality of servers and the shared storage system,
wherein each of the plurality of servers includes:
one or more non-volatile memories for storing part of the data stored in the shared storage system;
an interface for reading and writing data in the one or more non-volatile memories from and to the one or more non-volatile memories of another server via the network;
first access history information storing access status of data stored in the one or more non-volatile memories;
storage location information storing correspondence between the data stored in the one or more non-volatile memories and the data stored in the shared storage system; and
a first management unit for reading and writing data from and to the one or more non-volatile memories, reading and writing data from and to the one or more non-volatile memories of another server via the interface, or reading and writing data from and to the shared storage system via the interface, and
wherein the management server includes:
second access history information of an aggregation of the first access history information acquired from each of the plurality of servers; and
a second management unit for determining data to be allocated to the one or more non-volatile memories in each of the plurality of servers based on the second access history information.

2. A computer system according to claim 1, wherein the first access history information includes read counts and write counts of the data stored in the one or more non-volatile memories and read counts and write counts of the data stored in the shared storage system.

3. A computer system according to claim 1, wherein the first access history information stores the access status of data in individual units for acquiring histories initially defined in the one or more non-volatile memories.

4. A computer system according to claim 1, wherein the second management unit first determines data to be stored in the one or more non-volatile memories in each of the plurality of servers and notifies each of the plurality of servers of the data to be stored from the shared storage system to the one or more non-volatile memories in accordance with the determination.

5. A computer system according to claim 1,
wherein the first management unit sends and receives data between the one or more non-volatile memories of the server including the first management unit and the one or more non-volatile memories of another server using remote DMA, and
wherein the second management unit determines data to be allocated to the one or more non-volatile memories in each of the plurality of servers based on the second access history information and, in storing data from the shared storage system to the one or more non-volatile memories in each of the plurality of servers, temporarily prohibits each of the plurality of servers to use the remote DMA.

6. A method of controlling computer system to store data in a plurality of servers in the computer system including the plurality of servers each including a processor and a memory, a shared storage system for storing data shared by the plurality of servers, a network for coupling the plurality of servers and the shared storage system, and a management server for managing the plurality of servers and the shared storage system, the method comprising:
a first step of storing, by each of the plurality of servers, part of the data stored in the shared storage system to one or more non-volatile memories included in each of the plurality of servers;
a second step of generating, by each of the plurality of servers, first access history information by storing access status of data stored in the one or more non-volatile memories;
a third step of reading or writing, by each of the plurality of servers, data from or to the one or more non-volatile memories of the one of the plurality of servers, the one or more non-volatile memories of another server, or the shared storage system based on storage location information stored in each of the plurality of servers and indicating correspondence between the data stored in the one or more non-volatile memories and the data stored in the shared storage system;
a fourth step of generating, by the management server, second access history information by aggregating first access history information acquired from each of the plurality of servers; and
a fifth step of determining, by the management server, data to be allocated to the one or more non-volatile memories in each of the plurality of servers based on the second access history information.

7. A method of controlling computer system according to claim 6, wherein the first access history information includes read counts and write counts of the data stored in the one or more non-volatile memories and read counts and write counts of the data stored in the shared storage system.

8. A method of controlling computer system according to claim 6, wherein the second step includes storing the access status of data in individual units for acquiring histories initially defined in the one or more non-volatile memories to the first access history information.

9. A method of controlling computer system according to claim 6, wherein the fifth step includes determining data to be stored in the one or more non-volatile memories in each of the plurality of servers and then notifying each of the plurality of servers of the data to be stored from the shared storage system to the one or more non-volatile memories in accordance with the determination.

10. A method of controlling computer system according to claim 6,
wherein the third step includes sending or receiving data between the one or more non-volatile memories of one of the plurality of servers and the one or more non-volatile memories of another server using remote DMA, and
wherein the fifth step includes determining data to be allocated to the one or more non-volatile memories in each of the plurality of servers based on the second access history information and temporarily prohibiting each of the plurality of servers to use the remote DMA in storing data from the shared storage system to the one or more non-volatile memories in each of the plurality of servers.
